(19) United States
(12) Patent Application Publication
(10) Pub. No.: US 2019/0387201 A1
(43) Pub. Date: Dec. 19, 2019

(54) SYSTEMS AND METHODS FOR USING ARTIFICIAL INTELLIGENCE MONITORING IN LEGACY SURVEILLANCE SYSTEMS

(71) Applicant: Honeywell International Inc., Morristown, NJ (US)

(72) Inventors: Ishit Trivedi, Bangalore (IN); Hemant Mahsky, Bengaluru (IN); Sunil Venugopalan, Bangalore (IN); Jasmeet Bhatia, Gurgaon (IN); Atul Laxman Katole, Bangalore (IN); Jagadeesh Brahmajosyula, Bangalore (IN)

(21) Appl. No.: 16/008,518

(22) Filed: Jun. 14, 2018

(51) Int. Cl. H04N 7/18; G08B 13/196; H04N 7/01; G06K 9/00

(52) U.S. Cl. CPC H04N 7/18; G08B 13/19613; G06N 3/08; G06K 9/00771; H04N 7/0127

(57) ABSTRACT

Systems and methods for upgrading legacy surveillance systems to employ artificial intelligence based monitoring are provided. Such systems and methods can include a network interface device of a network connected device that can receive a primary data stream from a legacy surveillance system, a first processor of the network connected device that can receive user input identifying a type of the legacy surveillance system and process the primary data stream based on the type of the legacy surveillance system, and an artificial intelligence processor of the network connected device that can monitor the primary data stream as processed by the first processor to determine whether a current state of the secured area corresponds to a trigger condition and, when the current state of the secured area corresponds to the trigger condition, initiate a standard workflow for the type of the legacy surveillance system.

### FIELD

The present invention relates generally to systems and methods for using artificial intelligence to monitor a secured area. More particularly, the present invention relates to systems and methods for using artificial intelligence monitoring in legacy surveillance systems.

### BACKGROUND

Known systems and methods for monitoring a secured area employ legacy surveillance systems that continuously monitor the secured area and transmit data to a central monitoring station for assessment of any potential threat within the secured area. However, such known systems and methods can overload the central monitoring station with the data, thereby causing threats to be missed. Some known solutions have been developed that involve replacing all or some components of the legacy surveillance systems with new equipment that supports deep learning based analytics. However, the new equipment can be expensive and disruptive to install.

In view of the above, there is a continuing, ongoing need for improved systems and methods.

### BRIEF DESCRIPTION OF THE DRAWINGS

FIG. 1 is a block diagram of a network connected device in accordance with disclosed embodiments;

FIG. 2 is a perspective view of a network connected device in accordance with disclosed embodiments;

FIG. 3 is a block diagram of a system in accordance with disclosed embodiments; and

FIG. 4 is a flow diagram of a method in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods for upgrading legacy surveillance systems to employ artificial intelligence based monitoring. Such systems and methods can include a network connected device, network equipment, a remote monitoring station, and a legacy surveillance system deployed in a secured area. For example, in some embodiments, the legacy surveillance system can include closed circuit television (CCTV) hardware, such as security cameras, networked video recorders, and panel controllers.

The network connected device disclosed herein can include a network interface, such as a transceiver, that can receive a primary data stream from the legacy surveillance system and transmit signals to the remote monitoring station, a processor, and an artificial intelligence module, such as an artificial intelligence processor. In some embodiments, the network interface can include at least one of an Ethernet module, a Wi-Fi module, and a cellular module. Furthermore, in some embodiments, the network connected device can include a housing containing the network interface, the processor, and the artificial intelligence module, and in some embodiments, the housing can be located within or proximate to the secured area rather than at the remote monitoring station to limit bandwidth saturation of transmission infrastructure to the remote monitoring station.

The processor can receive user input identifying a type of the legacy surveillance system and process the primary data stream based on the type of the legacy surveillance system, for example, by decoding the primary data stream into first data readable by the artificial intelligence module. In some embodiments, the processor can receive the user input from a remote device (e.g. a computer, a mobile device, a tablet computer, a laptop computer, a cellphone, etc.) via the network interface, and in some embodiments, the processor can process the primary data stream by reducing a frame rate of the primary data stream.

In some embodiments, the primary data stream can be indicative of a current state of the secured area, and in these embodiments, the artificial intelligence module can monitor the primary data stream as processed by the processor, that is, the first data, to determine whether the current state of the secured area corresponds to a trigger condition and, when the current state of the secured area corresponds to the trigger condition, initiate a standard workflow for the type of the legacy surveillance system . In some embodiments, the trigger condition can be based on the type of the legacy surveillance system, and in some embodiments, the trigger condition can include at least one of detecting a person in the secured area attempting to hide an identity of the person by wearing a mask or a helmet, detecting multiple people being present in the secured area in excess of a predetermined number, detecting a presence of unexpected motion in the secured area, and detecting a face.

In some embodiments, the standard workflow can include the network connected device transmitting an alert notification identifying the trigger condition to the remote monitoring station via the network interface, and in some embodiments, the alert notification can include the first data indicative of the current state of the secured area. For example, the first data can include audio, video, or pictographical data captured from the secured area. In some embodiments, the artificial intelligence module can reduce a number of alert notifications sent to the remote monitoring station as compared to the legacy surveillance system acting alone without the network connected device.

In some embodiments, the primary data stream can be indicative of a presence of a preferred customer within the secured area, and in these embodiments, the artificial intelligence module can monitor the primary data stream as processed by the processor, that is, the first data, to recognize the presence of the preferred customer within the secured area and, when the presence of the preferred customer is identified within the secured area, send a preferred customer notification indicative of the presence of the preferred customer within the secured area to an operator of the secured area instructing the operator to provide the preferred customer with priority service.

In some embodiments, the artificial intelligence module can include an artificial intelligence model saved in a database device of the artificial intelligence module and trained to recognize the trigger condition or the preferred customer. In some embodiments, the artificial intelligence model can include a deep learning algorithm trained using historical data from the legacy surveillance system during known scenarios, such as, for example, when the trigger condition or the preferred customer was detected within the secured area. In this regard, the artificial intelligence model can analyze the historical data to identify patterns and other features of the first data from the legacy surveillance system that are indicative of the known scenarios, that is, the trigger condition or the preferred customer being detected within the secured area. In some embodiments, the artificial intelligence model disclosed herein can include recurrent neural networks and deep neural networks.

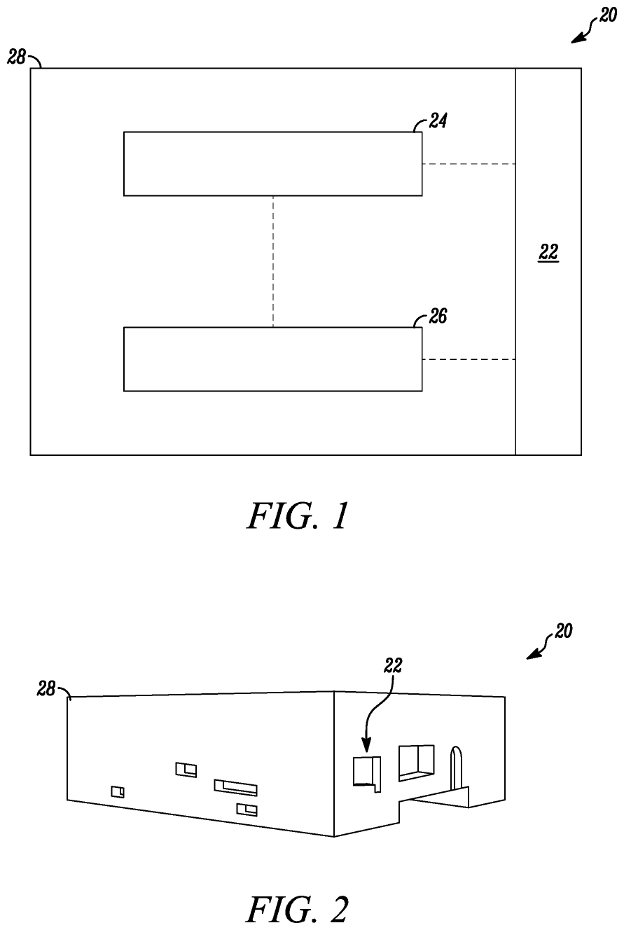

FIG. 1 is a block diagram of a network connected device 20 in accordance with disclosed embodiments, and FIG. 2 is a perspective view of the network connected device 20 in accordance with disclosed embodiments. As seen, the network connected device 20 can include a network interface 22 (transceiver), a processor 24, an artificial intelligence module 26, and a housing 28. In some embodiments, the network interface 22 can include at least one of an Ethernet module, a Wi-Fi module, and a cellular module for connecting the network connected device 20 to a local network of a legacy surveillance system. In some embodiments, the artificial intelligence module 26 can be separate from the processor 24, and in some embodiments, the artificial intelligence module 26 can be integrated with the processor 24.

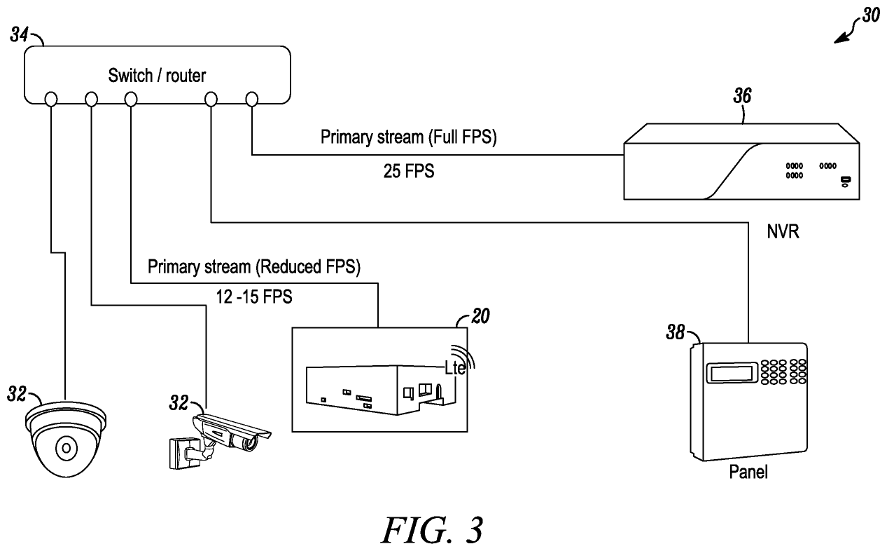

FIG. 3 is a block diagram of a system 30 in accordance with disclosed embodiments. As seen in FIG. 3, the system 30 can include the network connected device 20 and the legacy surveillance system, including network enabled cameras and sensors 32, a network switch and/or router 34, a network video recorder 36, and a control or access panel 38.

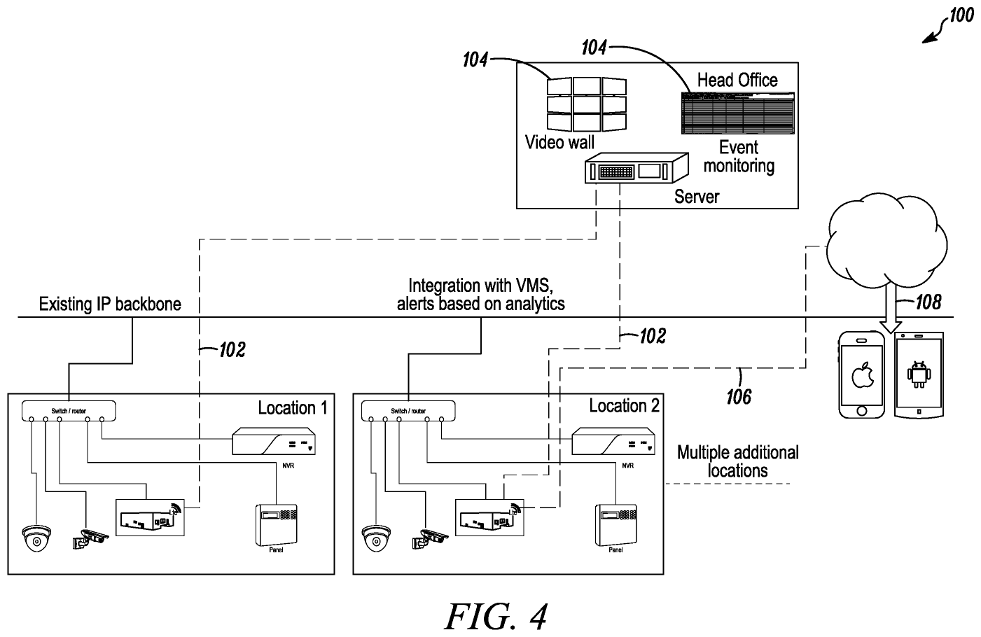

FIG. 4 is a flow diagram of a method 100 in accordance with disclosed embodiments. As seen in FIG. 4, the method 100 can include the network connected device 20 at one or more of a plurality of secured areas using a primary data stream received from the legacy surveillance system at a respective one of the plurality of locations to identify a trigger condition and transmitting an alert notification identifying the trigger condition to a remote monitoring station, as in 102, and/or transmitting the alert notification identifying the trigger condition to a cloud server, as in 106. In some embodiments, the network connected device 20 can transmit the alert notification identifying the trigger condition to the remote monitoring station and/or the cloud server via a first communication medium that is different from a second communication medium (existing IP backbone) via which the legacy surveillance system itself, such as the network switch and/or router 34, communicates with the remote monitoring station and/or the cloud server. When the remote monitoring station receives the alert notification, the method 100 can include a server at the remote monitoring station processing and displaying the alert notification on a video wall or a computer terminal, as in 104. When the cloud server receives the alert notification, the method 100 can include the cloud server parsing the alert notification and transmitting the alert notification to one or more mobile devices, as in 108.

It is to be understood that the network connected device disclosed herein can include a transceiver device and a memory device, each of which can be in communication with control circuitry, one or more programmable processors, and executable control software as would be understood by one of ordinary skill in the art. In some embodiments, the control software can be stored on a transitory or non-transitory computer readable medium, including, but not limited to local computer memory, RAM, optical storage media, magnetic storage media, flash memory, and the like, and some or all of the control circuitry, the programmable processors, and the executable control software can execute and control at least some of the methods described herein.

Although a few embodiments have been described in detail above, other modifications are possible. For example, the steps described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A system comprising:
a network interface device that receives a primary data stream from a legacy surveillance system indicative of a current state of a secured area monitored by the legacy surveillance system;
a first processor that receives user input identifying a type of the legacy surveillance system and processes the primary data stream based on the type of the legacy surveillance system; and
an artificial intelligence processor that monitors the primary data stream as processed by the first processor to determine whether the current state of the secured area corresponds to a trigger condition and, when the current state of the secured area corresponds to the trigger condition, initiates a standard workflow for the type of the legacy surveillance system.

2. The system of claim 1 wherein the trigger condition includes at least one of detecting a person in the secured area attempting to hide an identity of the person by wearing a mask or a helmet, detecting multiple people being present in the secured area in excess of a predetermined number, detecting a presence of unexpected motion in the secured area, and detecting a face.

3. The system of claim 1 wherein the standard workflow includes transmitting an alert notification identifying the trigger condition to a remote monitoring station.

4. The system of claim 3 wherein the alert notification includes first data from the primary data stream indicative of the current state of the secured area.

5. The system of claim 3 wherein the artificial intelligence processor transmits the alert notification to the remote monitoring station via the network interface device.

6. The system of claim 1 wherein the first processor receives the user input from a remote device via the network interface.

7. The system of claim 1 wherein the network interface includes at least one of an Ethernet module, a Wi-Fi module, and a cellular module.

8. The system of claim 1 further comprising a housing containing the network interface device, the first processor, and the artificial intelligence processor and located within or proximate to the secured area.

9. The system of claim 1 wherein the artificial intelligence processor monitors the primary data stream as processed by the processor to recognize a presence of a preferred customer within the secured area and, when the presence of the preferred customer is identified, sends a preferred customer notification to an operator of the secured area identifying the presence of the preferred customer within the secured area and instructing the operator to provide the preferred customer with priority service.

10. The system of claim 1 wherein the first processor processes the primary data stream by reducing a frame rate of the primary data stream.

11. A method comprising:
connecting a network connected device to a legacy surveillance system;
the network connected device receiving, via a network interface, a primary data stream from the legacy surveillance system indicative of a current state of a secured area monitored by the legacy surveillance system;
a first processor of the network connected device receiving user input identifying a type of the legacy surveillance system;
the processor processing the primary data stream based on the type of the legacy surveillance system;
an artificial intelligence processor of the network connected device monitoring the primary data stream as processed by the first processor to determine whether the current state of the secured area corresponds to a trigger condition; and
when the current state of the secured area corresponds to the trigger condition, the artificial intelligence processor initiating a standard workflow for the type of the legacy surveillance system.

12. The method of claim 11 wherein the trigger condition includes at least one of detecting a person in the secured area attempting to hide an identity of the person by wearing a mask or a helmet, detecting multiple people being present in the secured area in excess of a predetermined number, detecting a presence of unexpected motion in the secured area, and detecting a face.

13. The method of claim 11 further comprising transmitting an alert notification identifying the trigger condition to a remote monitoring station

14. The method of claim 13 further comprising including first data from the primary data stream indicative of the current state of the secured area with the alert notification.

15. The method of claim 13 further comprising transmitting the alert notification to the remote monitoring station via the network interface.

16. The method of claim 11 further comprising the first processor receiving the user input from a remote method via the network interface.

17. The method of claim 11 wherein the network interface includes at least one of an Ethernet module, a Wi-Fi module, and a cellular module.

18. The method of claim 11 wherein the network connected device is located within or proximate to the secured area.

19. The method of claim 11 further comprising:
the artificial intelligence processor monitoring the primary data stream as processed by the processor to recognize a presence of a preferred customer within the secured area; and
when the presence of the preferred customer is identified, the artificial intelligence processor sending a preferred customer notification to an operator of the secured area identifying the presence of the preferred customer within the secured area and instructing the operator to provide the preferred customer with priority service.

20. The method of claim 11 further comprising the first processor processing the primary data stream by reducing a frame rate of the primary data stream.
